(19) United States
(12) Patent Application Publication
(10) Pub. No.: US 2013/0325980 A1
(43) Pub. Date: Dec. 5, 2013

(54) SYSTEM AND METHOD FOR CREATING AND DELIVERING COMPLEX GRAPHIC EMAILS WHICH AUTOMATICALLY ADAPT TO FIT A VARIETY OF DIFFERENT RECIPIENT DEVICES

(71) Applicant: Shimon OHAYON, Tel-Aviv (IL)

(72) Inventor: Shimon OHAYON, Tel-Aviv (IL)

(21) Appl. No.: 13/858,959

(22) Filed: Apr. 9, 2013

Related U.S. Application Data
(60) Provisional application No. 61/653,429, filed on May 31, 2012.

(51) Int. Cl. H04L 12/58

(52) U.S. Cl. CPC H04L 51/066
USPC 709/206

(57) ABSTRACT

A method and system for providing an email that is configured to be displayed based on a type of email platform upon which the email is displayed, the method including: (a) obtaining a plurality of sets of image files, each of the set of image files adapted for display on a respective email platform; (b) sending a multi-view email to a recipient email platform; (c) receiving an image request from the recipient email platform; (d) sending a set of image files adapted for display on an email platform similar to the recipient email platform.

This patent application claims the benefit of, and priority from, U.S. Provisional Patent Application No. 61/653,429, filed May 31, 2012

### FIELD AND BACKGROUND OF THE INVENTION

The present invention relates to email marketing tools and, more particularly, to a system and method for creating and delivering complex graphic emails to variety of different recipient email platforms so as to be viewed properly and optimally on each platform.

Email systems handle email messages in either a plain/rich-text format (e.g., American standard code for information interchange (ASCII)) or an encoded format (e.g., hyper-text markup language (HTML), multi-purpose Internet mail extension (MIME), etc.). While plain/rich-text email messages are sufficient for simply conveying message content to intended recipients, these plain/rich-text email messages provide very few options on how the email messages are displayed due to their limited functionality.

Conversely, email messages in encoded formats have greater functionality. For example, HTML-formatted email messages may include links to bitmap images that are directly embedded into the email message itself. Therefore, theoretically, when a recipient receives the HTML-formatted email message, the embedded bitmap image should automatically be displayed (via the link) to the recipient in an email read window.

The use of business and commercial marketing emails has expanded at an accelerated rate in recent years. Business and commercial marketing emails are becoming richer with graphics and content, and demand complex design and layout. Commercial marketing emails serve to maintain contact with clients, promote commercial web sites, and especially to promote and cultivate large and varied client clubs with thousands of members. In the commercial email field, it is essential to offer a graphic cover that is professional, polished, well adapted and easy to view and read. An email message that is not optimally presented, (text that is too small, cut images, incompatibility with screen size etc.) does not achieve the desired goal and may even cause marketing damage.

By nature, email is a service that is based on internet communication and built according to assigned protocols, designed to maintain uncompromising Information Security (much stricter than regular web activity). An email sent to a recipient passes through many filters and code proof-readers, so that the email reaches the recipient in the format suited to the strict Information Security policy (in order to prevent the penetration of malicious code, Trojan horses, viruses, spam, phishing etc). As a result the email protocols fully block all transfer and activation of interactive components. Once an email has been sent, the source code of the email page cannot be altered.

The aforementioned uncompromising information security policy places extreme graphic restrictions on emails. Specifically, it is not possible to execute any adaptation of an email to the specific reading/viewing platform in real time, when opening the email. This is due to the fact that at this point (i.e. once the email has been downloaded to the particular platform) the email is completely disconnected from the sender. Therefore, a recipient receives only the original code of the email page and there is no manner in which the sender can send any more code (to the email) or to make any changes in the code which will cause the email to adapt to the host platform. That is to say that an email, which, for example, includes an embedded graphic that is designed to be optimally displayed on a desktop screen, cannot be remotely instructed by the sender to adapt to the current host, even when the hosting platform cannot properly display the optimal layout and graphic due to the screen being a much smaller size (e.g. on a smartphone). It is furthermore not possible to activate any system or update logic in the recipient email platform to perform the necessary adaptation.

Strict protocols and standards dictate that email servers and platforms are set to filter graphic rich code and only allow a limited and reduced code that contains a limited amount of graphic and geometric tags and definitions. It is important to note that the aforementioned strict restrictions are derived from the severe standards that were set for email protocols, and therefore cannot be bypassed with a trivial or technological solution. The current state of affairs is not expected to change in the near future, in spite of the challenge present by the large variety of email platforms which exist today.

There is also an enormous growth of quantity and variety of new platforms which are capable of receiving and displaying emails: smart phones, tablets in different sizes, interactive TV sets and more. There is currently no forecast or identified tendency to unite display formats or screen sizes. Furthermore, working/viewing environments are steadily increasing, for example: desktop computers, tablets, smartphones, interactive vehicle interfaces, interactive TV sets, household appliance operating screens and so forth. Each of these categories is characterized by unique environmental elements such as: viewing distance, lighting conditions etc.

Beyond these difficulties one can never know on which platform the email will be viewed. This is not a problem with websites. Web pages, unlike emails, are able to detect the browser-type and platform which the end-user is using and send the correct/designated version of the page to the browser. But this is not so in the case of email. As discussed above, once an email is sent, the sender can no longer control the email and whatever version was sent is the version that the recipient will receive—much like regular mail sent through the Post office.

The problem facing a client who wishes to send emails which are graphically enhanced is that, simply stated, email that is designed to be displayed by one platform, (for example, on a standard desktop screen) will not display correctly on a email mobile application (app) on a second platform (for example, an iPhone™ mobile device) and vice versa.

A further problem, which is even more difficult to surmount, is that the same recipient will wish to view the same email on various platforms, for example, switching between a desktop and a smartphone. In the latter case, half the time the email version will be inappropriate.

In summary, one cannot know in advance which email platform a given email will be displayed on and no solution exists which allows for the use of a graphic engine or code that will adapt an email graphic to the receiving platform.

Two existing, but unsatisfactory solutions are used in practice. The first solution is to create multiple versions of the same promotional email, where each version is adapted for a particular platform. For example, one version of the marketing email is created for Gmail™ viewed on a standard desktop screen with three columns and a second version is created for display on a smartphone, with only one column. Now that the marketer has two versions of the same email, the marketer can choose which email to send to which recipient (possibly according to statistical data gathered previously). One problem with this solution is that much of the time the decision will be incorrect resulting in the recipient receiving an email in the incorrect format which will not be displayed properly. But, even in the case where the marketer guessed correctly, it is common for a user to view the same email on a second or even third platform. The same email that displayed so nicely on the first platform will now be incorrectly (or at least not optimally) displayed on the second and third platforms. A second solution is to use an alternative application to display the content by adding a button or link such as: “If you can't read/see this email click here”, where, upon clicking the button or link, the email is displayed on the end-user browser. This solution also suffers from a number of drawbacks. End-users do not wish to wait for an email to be displayed in the browser (which necessitates inconvenient switching between browser and email application), especially not a promotional email which is generally only considered for a few seconds before the recipient decides whether to discard or followed-up en email (this is also one reason why promotional emails must display correctly the first time in order to catch the attention of the recipient, who is likely to see many such emails during the course of the average day). Furthermore, smartphone users cannot easily or conveniently switch between email applications and browsers and only the most advanced devices are able to support multiple web-pages in parallel.

No comprehensive solution has been offered to date which provides a method and system for providing a graphically enhanced email with no interactive components (i.e. no executable code) which is able to nonetheless adapt itself to the platform upon which the email is being displayed.

It would be highly advantageous to have a system and process for creating single multi-view emails that are graphically enhanced while being automatically displayed in an optimal manner on any email platform without the assistance or mediation of external tools and without having any interactive or executable components.

### Definitions

The term ‘email platform’ is used herein to refer to the hardware device used for viewing emails. Hardware platforms refer to the various devices on which an email can be viewed such as: a desktop monitor, an iPad or Tablet computer, a digital reader such as a Kindle™, palm sized handheld device such as a PDA, a smartphone (e.g. iPhone, Galaxy etc), and any other type of device capable of displaying an email.

The term ‘Email Client’ refers to email reader software applications such as: Outlook™, Eudora, IBM Lotus Notes, Opera Mail to name just a few. Furthermore, Email Client can also refer to web-based interfaces such as Squirrelmail, Roundcube, Gmail™, Yahoo! Mail™, Hotmail™ and the like. Also included in the term platform are mobile applications such as a Gmail™ (or similar) app (mobile application) for smartphones and tablet computers. As used herein, ‘email platform’ is intended to refer to the hardware platform on which the email is displayed, unless otherwise stated.

The term ‘interactive components’ and ‘executable code’ refer herein to elements of the program script that are included or embedded in the Web page email which activate executable code on the client side.

The term ‘Identifying Information’ refers to the characteristics of a platform, that may include: Device/hardware vendor/type/model, product name/version, application type, operating system or software revision.

For example: transferring the Identifying Information can be done by submitting the platform “user agent string” (this identification is transmitted in a header field User-Agent).

### SUMMARY OF THE INVENTION

The present invention successfully addresses the shortcomings of the presently known configurations by providing a

[symbol]

According to the present invention there is provided a method for providing an email that is configured to be displayed according to display parameters of an email platform upon which the email is displayed, the method comprising: (a) obtaining a plurality of sets of image files, each the set of image files adapted to be displayed according to display parameters of a respective email platform; (b) sending a multi-view email to a recipient email platform; (c) receiving an image request from the recipient email platform; and (d) sending a set of image files adapted for display on an email platform similar to the recipient email platform.

According to further features in preferred embodiments of the invention described below the set of image files includes: (i) at least one content image file; and (ii) at least one layout image file.

According to still further features in the described preferred embodiments the image request includes information identifying the recipient email platform.

According to still further features the method further includes a step of: (e) retrieving the set of image files adapted for display on the email platform similar to the recipient email platform based on the identifying information; wherein step (e) is performed prior to step (d).

According to still further features the step of retrieving is performed by an Image Response Application (IRA) adapted to redirect the image request, based on the identifying information, to a sub-repository containing the set of image files adapted for display on the email platform similar to the recipient email platform.

According to still further features the step of retrieving is performed by an Image Response Application (IRA) adapted to retrieve the set of image files adapted for display on the email platform similar to the recipient email platform from an Image File Repository and rename the set of images to conform with the image files requested in the image request.

According to still further features the multi-view email includes only non-executable instructions.

According to still further features the multi-view email is configured to display substantially similar content on each respective email platform.

According to still further features at least some of the substantially similar content is invisible when displayed on at least one of the respective email platforms.

According to still further features the substantially similar content includes indicia of source from which the substantially similar content originated.

According to another embodiment there is provided a system for preparing a multi-view email adapted to be displayed according to display parameters of an email platform upon which the email is displayed, including: (a) a Layout Image File creator for creating a respective set of Layout Image Files for display on each of a plurality of email platforms; (b) an Image Editor adapted to edit a respective set of Content Image Files to conform to a respective set of Layout Image Files; and (c) a multi-view email creator configured to creating a single multi-view email configured to display a set of Layout Image Files and a set of Content Image Files adapted for display according to display parameters of an email platform similar to a recipient email platform upon which the multi-view email is being displayed.

According to another embodiment there is provided an email system for distributing a multi-view email adapted to be displayed according to display parameters of an email platform upon which the email is displayed, including: (a) an Image File Repository (IFR) configured to store image files; and (c) an Image Response Application (IRA) operationally coupled to the IFR and configured to respond to image requests from recipient email platforms; wherein the multi-view email is configured to display substantially similar content respectively on each of a plurality of the recipient email platforms.

According to further features the image files include: (i) at least one Layout Image File, and (ii) at least one Content Image File.

According to further features the image requests include identifying information identifying the recipient email platform displaying the multi-view email.

According to further features the IRA, is response to an image request, is adapted to retrieve image files from the IFR based on the identifying information in the image request.

According to further features the retrieved image files are renamed to conform to requested image files included in the image request.

According to further features the IFR includes a plurality of sub-repositories, wherein each respective sub-repository being identified as corresponding to a respective recipient email platform and wherein each sub-repository is adapted to store image files adapted for display on the corresponding recipient email platform.

According to further features the IRA is configured to redirect the image request, based on the identifying information, to a sub-repository corresponding to the recipient email platform identified by the identifying information.

According to another embodiment there is provided a computer-readable medium having computer-readable code for displaying a multi-view email on a programmable receiving email client according to display parameters of an email platform running the email client, the computer-readable medium including: (a) computer-readable code adapted to instruct the email client to display content of a hypertext markup language (HTML) formatted email message within a default width; (b) computer-readable code adapted to instruct the email client to send an image request for image files from an email server, wherein the image request includes information identifying the email platform; and (c) computer-readable code adapted to instruct the email client to download and display the image files; wherein the image files include at least one Layout Image File adapted to provide the email client with parameters for displaying the content, wherein the parameters conform to the display parameters of the email platform running the email client.

According to further features the image files further includes at least one Content Image File adapted to be displayed within at least one Layout Image File.

The present invention discloses an innovative solution for providing a single email which is capable of providing the appropriate view to various undetermined email platforms. At the first stage a single ‘multi-view email’ is sent to a marketing email list regardless of the recipients' email platforms. Each single ‘multi-view email’ is designed to serve all target email platforms.

In the second stage, when a ‘multi-view email’ is opened by the recipient, the email displays the text with the picture place holders. (In general, all regular emails as well as ‘multi-view-emails’ display only the text with the picture place holders when first opened. Only when the user asks to “Download Pictures” or has approved in the past to “Download all pictures from this address”, are the pictures then are downloaded and the email gets its final and complete graphic shape.)

In the third stage a request to download pictures is sent to the ‘multi-view-email’/system email server. When the ‘multi-view-email’ server receives the request to download the relevant pictures, all the necessary information about the target email platform is sent together with the download request (a target email platform may be, for example, an iPhone, IOS 5, Gmail app etc.). In the ‘multi-view-email’ server there is a designated directory serving each different target platform (For example, in the previous case we have a unique directory for iPhone, iOS 5, Gmail app). These designated directories contain all the pictures which are designed to serve this specific email file when it is opened in a specific email platform. Every directory has a set of pictures with the same names as the pictures in the default/base email/sample email page. The pictures in each directory have been appropriately sized to fit the target email platform layout.

The target email platform-specific directories in the multi-view-email server actually contain two different types of pictures/images—content pictures (the common pictures photos and drawings embedded in any marketing email) and unique and innovative ‘multi-view-email’ Layout Image Files.

The “Layout Image Files” are image objects that determine the layout or geometric construction of the email when the email is opened in a specific email platform. The image objects are both vertical and horizontal. These images are generally transparent and are one pixel thick, but in some embodiments, for example, the images have the same color as their background and in some embodiments the images are more than one pixel thick. The idea of these Layout Image Files is that once the email is displayed then the Layout Image Files become invisible (however, as mentioned above, in some cases it is indeed possible that the images will not be transparent due to graphic/artistic considerations).

In the fourth stage, the Layout Image Files are downloaded to the email recipient platform, in the same way and at the same time as the content pictures are downloaded. At this point, the system innovatively spreads out the appropriate layout of the multi-view email to fit the target email platform display parameters.

The email's content pictures (stored on the ‘multi-view-email’ server) that have been appropriately sized to fit the downloaded layout are embedded in the layout and the email text is automatically aligned to fit the appropriate layout text slots.

The result is that the multi-view email is displayed in a layout with appropriately sized pictures that adequately displays the email according to the constraints of the display space available on the recipient email platform.

### BRIEF DESCRIPTION OF THE DRAWINGS

Various embodiments are herein described, by way of example only, with reference to the accompanying drawings, wherein:

FIG. 1 is a flow chart of the innovative process for creating and delivering the innovative multi-view email;

FIG. 2 is an exemplary depiction of three optimized email page simulations, for three different exemplary platforms;

FIG. 3 is a depiction of the displays of FIG. 2 including various dimensions of the objects depicted therein;

FIG. 4 is a depiction of exemplary Layout Image Files for the email versions of FIG. 2, created at the authoring/editing stage;

FIG. 5 is a depiction of the default layout-less display of the email versions of FIG. 2, at the stage prior to the Layout Image Files and Content Image Files being downloaded and displayed in the emails;

FIG. 6 is a depiction of the Layout Image Files of FIG. 4 being displayed on the exemplary platforms, at the stage prior to the Content Image Files being displayed;

FIG. 7 is a depiction of the displays of FIG. 6 with the Layout Image Files not visible;

FIG. 8 is an illustrative work flow of the redirect process of the Image Response Application;

FIG. 8a is an illustrative another work flow of the redirect process of the Image Response Application;

FIG. 9 is a block diagram of an exemplary architecture used for email transport and delivery used in several embodiments of the present invention;

FIG. 10 is a block diagram of an embodiment of the web server shown in FIG. 9.

### DESCRIPTION OF THE PREFERRED EMBODIMENTS

The principles and operation of a system and process for creating multi-view emails according to the present invention may be better understood with reference to the drawings and the accompanying description.

All email clients today are able to display text emails in a suitable manner, no matter what email platform/device the email is being displayed on. The problem begins when emails are in encoded email formats and include multi-column and/or graphics and/or images. Most email clients have layered security protocols whereby text emails are automatically viewable but the graphic components of those same emails are blocked. In these cases, ‘picture placeholders’ are displayed, literally reserving the place for the pictures which may or may not be downloaded.

In some very strict protocols, graphics are never allowed. In the overwhelming majority of platforms, though, graphics are generally allowed once the end-user has manually allowed the Image Files (pictures, drawing, logos, etc. . . . ) to be downloaded or has previously allowed emails from a given source to have the graphics automatically downloaded.

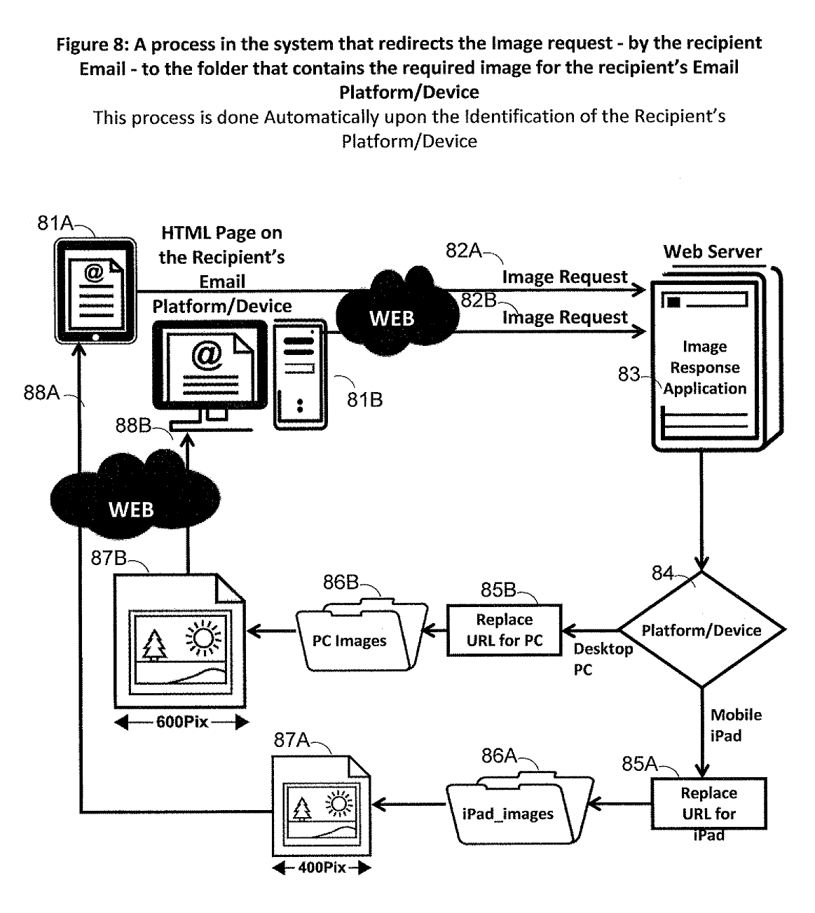

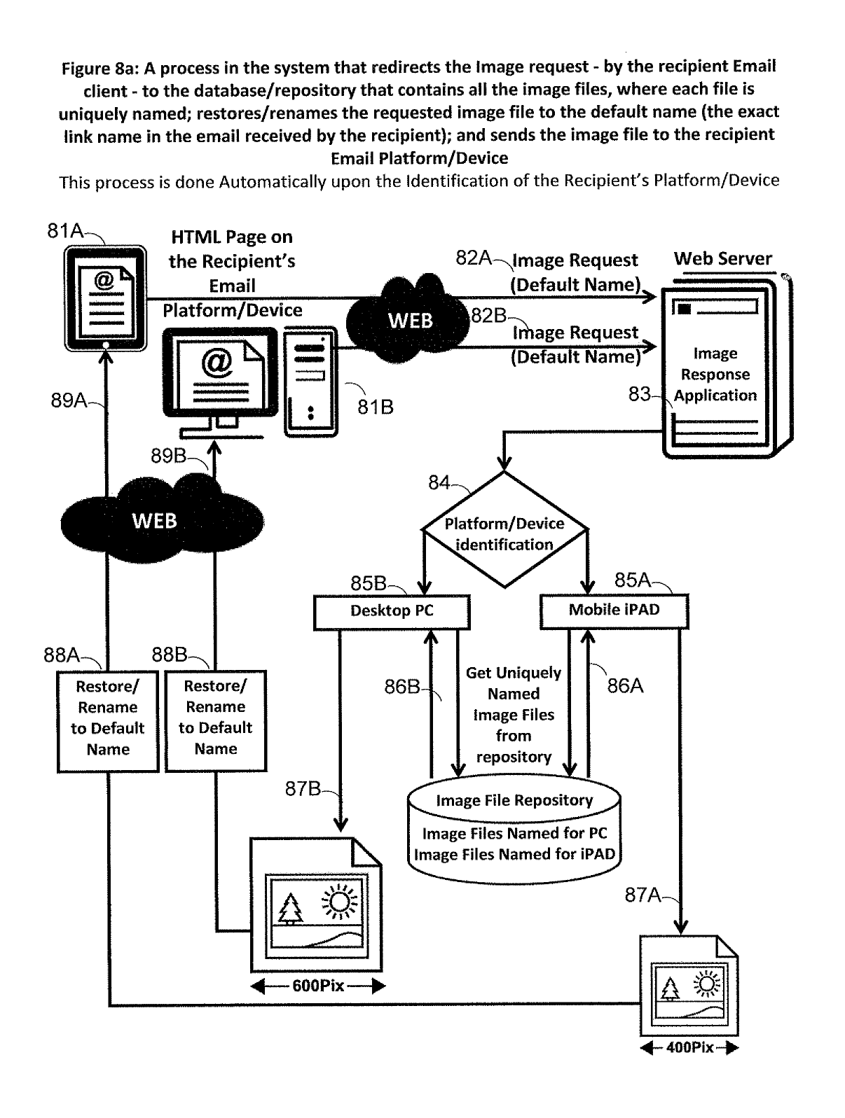

When the manual or automatic command to download the pictures is given, the email platform sends a request to the email server (see below regarding FIG. 8 for further detail) from which the email originated, requesting the specific pictures for the specific email. The pictures are then downloaded and displayed in place of the picture placeholders. E.g. Picture 1 is displayed in place of placeholder 1 and picture 2 is displayed in place of placeholder 2 etc.

What has just been described is what happens from the point of view of the end-user reading the email. From the point of view of the source code of the email, the HTML script of the email includes the filename and location of the image/graphic file in the form of a URL. As mentioned, the image/graphic file is first displayed as a picture placeholder and only once the actual image file has been downloaded is the picture itself then displayed. In the script, the reference to the image file usually appears as “src=‘http://public.files.publications.com/2012/11/picture1.gif?w=150;h=105’” or the like. The quoted instruction tells the email platform to look up the provided URL and retrieve or download the image stored there.

At this point the image is displayed. How the picture is displayed is also a question of great consideration in the immediate application. An image file includes many parameters, and of those, the parameters regarding the size of the picture are currently of importance to the discussion. The size of the picture is generally referred to by a W×H (e.g. 268×188) designation, i.e. a given Width by a given Height. The numbers refer to the amount of pixels across the screen (width) and up the screen (height), defining the surface area of the image.

The general idea is to stretch the full email page or shrink the page to fit the screen of the target platform. The size and dimensions of the email are determined by the size of the page. The email is prepared in such a way that it more or less fits the target screens, and in case of a minor discrepancy the mobile devices themselves “know” how to stretch or shrink the emails to fully fit the screen.

### Process

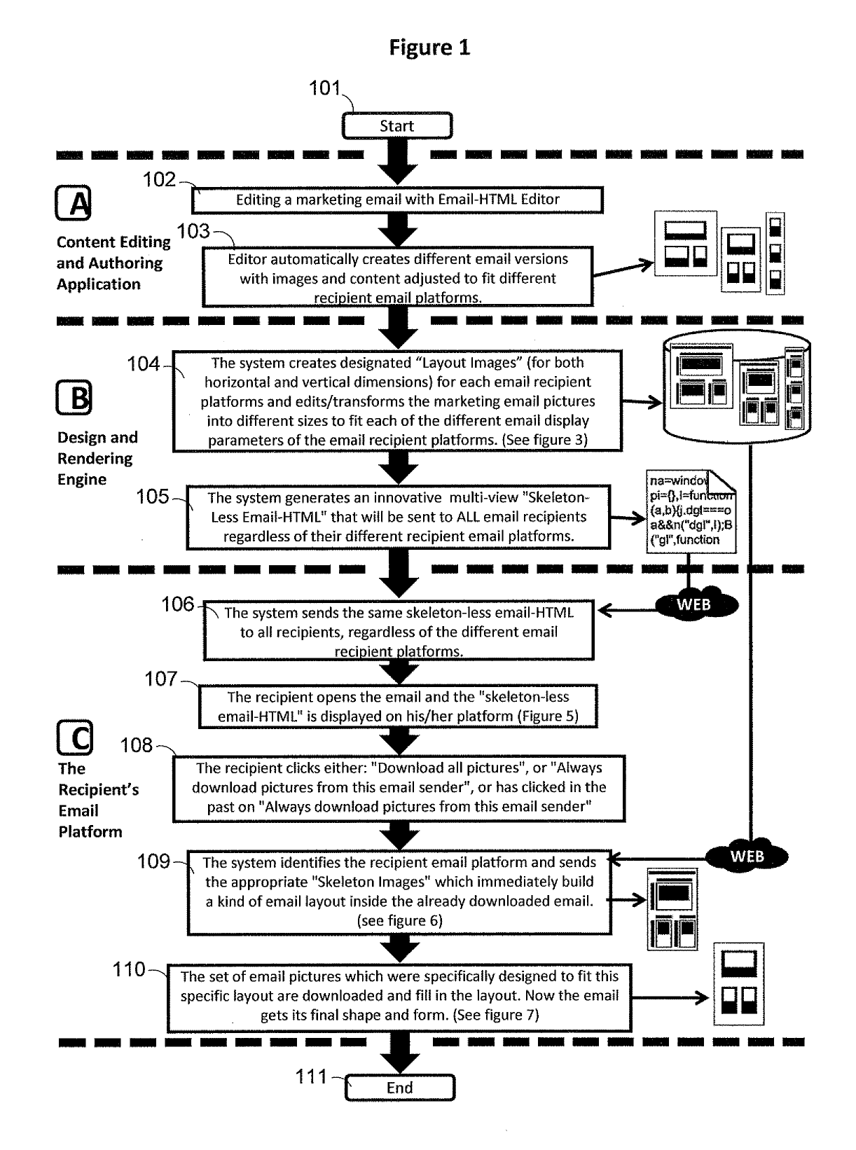

Referring now to the drawings, FIG. 1 illustrates a flow chart of the innovative process for creating and delivering the innovative multi-view email. The flow chart depicts a method/process employed to create and deliver a complex graphic email that is automatically adapted to fit the recipient email platform which is just one of a variety of different recipient email platforms that the innovative email is capable of adapting itself to. The process is performed without the use of a web-browser and without identifying the email recipient platform before sending the email.

Step 101 begins the process. The innovative system receives a marketing email (or the like) or content of a marketing email from a marketing client (referred to hereinafter as a “marketer”, although this reference integral meaning as it is used herein to refer to client wishing to send a graphically enhanced email, this could be an advertiser, a political candidate, a governmental body or indeed anyone wishing to send such an email).

At Step 102, the content of a ‘base email’ or ‘sample email’ page including content created for a marketer (which is usually optimized for viewing/display on a PC) is entered into the system Email-HTML Editor which is a Content Editing and Authoring Application. The Editor may be integrated into the general email server system that sends the email, or a standalone entity for providing the necessary materials needed to support the multi-view email.

At Step 103 the editor creates a number of email versions extrapolated from the ‘base email’, sample email page or default email originally received from the marketer or email content received from the marketer. The email versions are automatically created for the various potential email platform displays according to the needs of the marketer. Some marketers may elect to create a multi-view email that is capable of being optimally displayed on all the currently known platforms while other may elect three or four of the most commonly used platforms. The various email versions are optimized for view on each of the chosen target platforms. That is to say that each of the email versions has, generally speaking, the same content (or substantially similar content) to the content of the base email, but that each email version is adapted to display that content within predefined display parameters of a respective selected email platform.

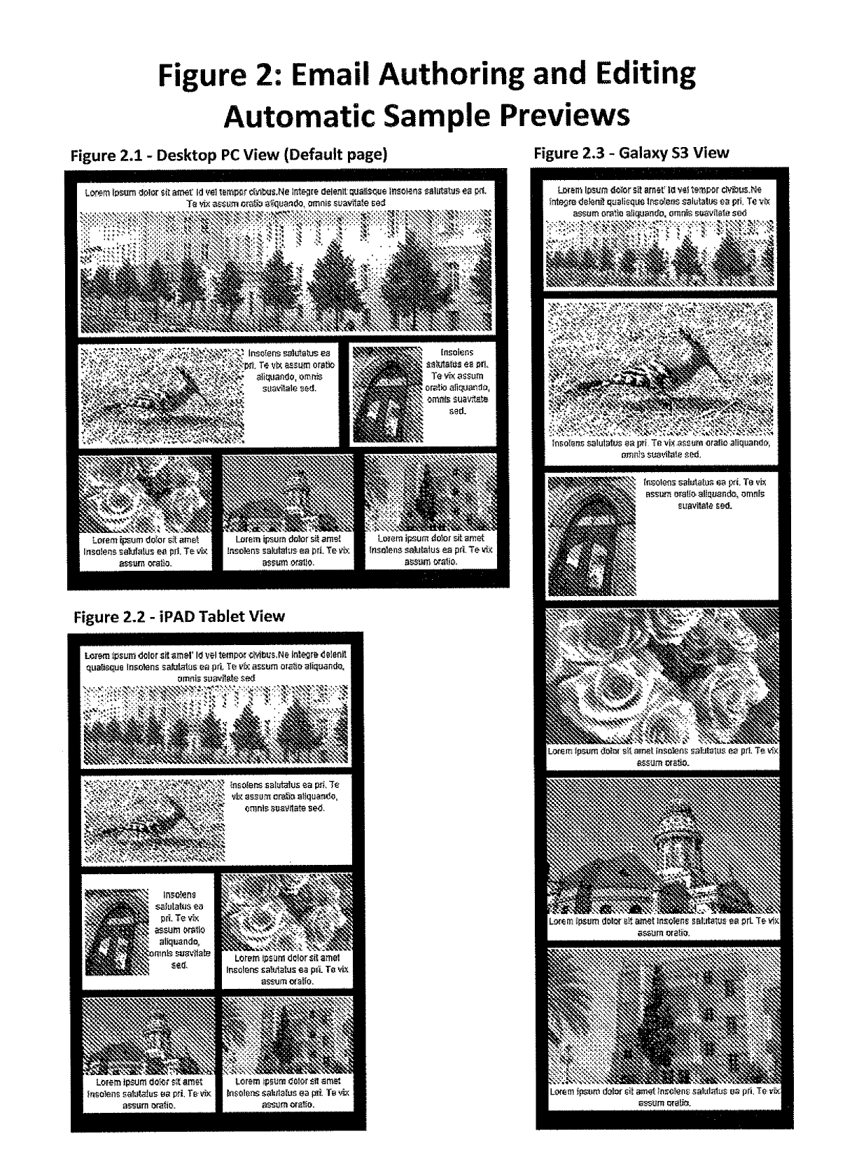

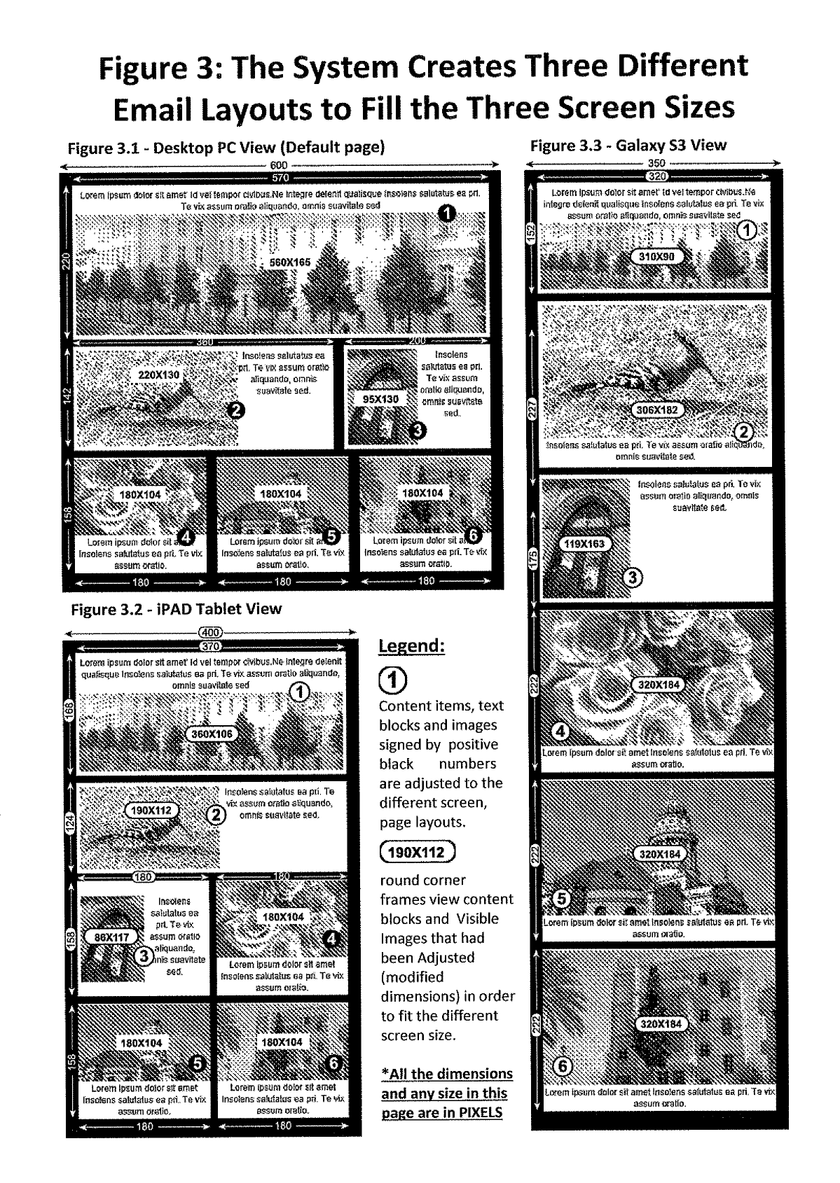

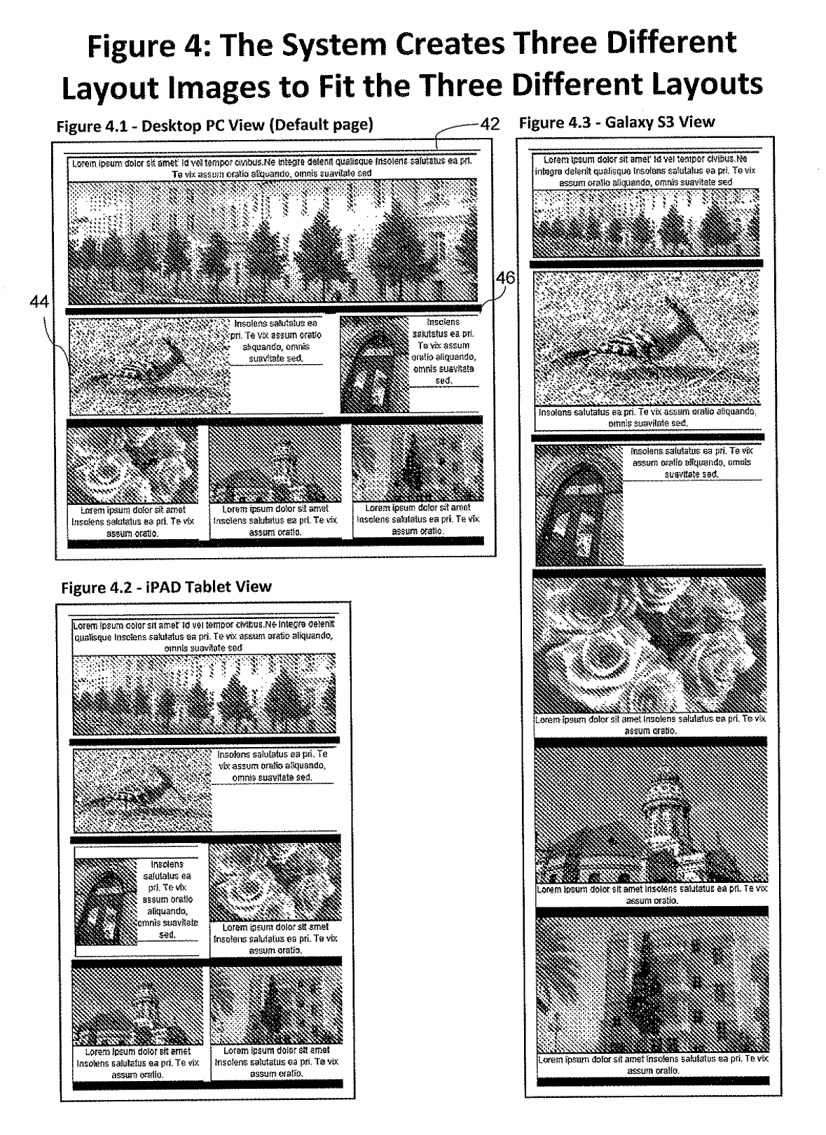

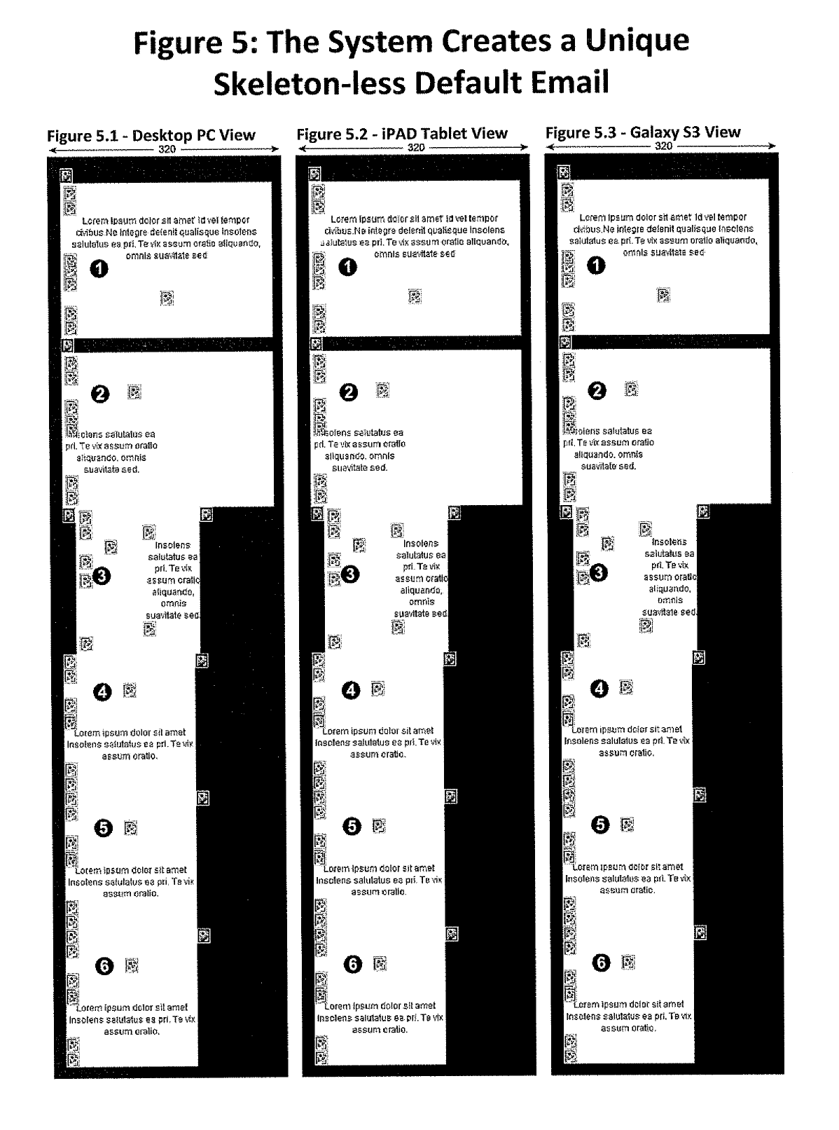

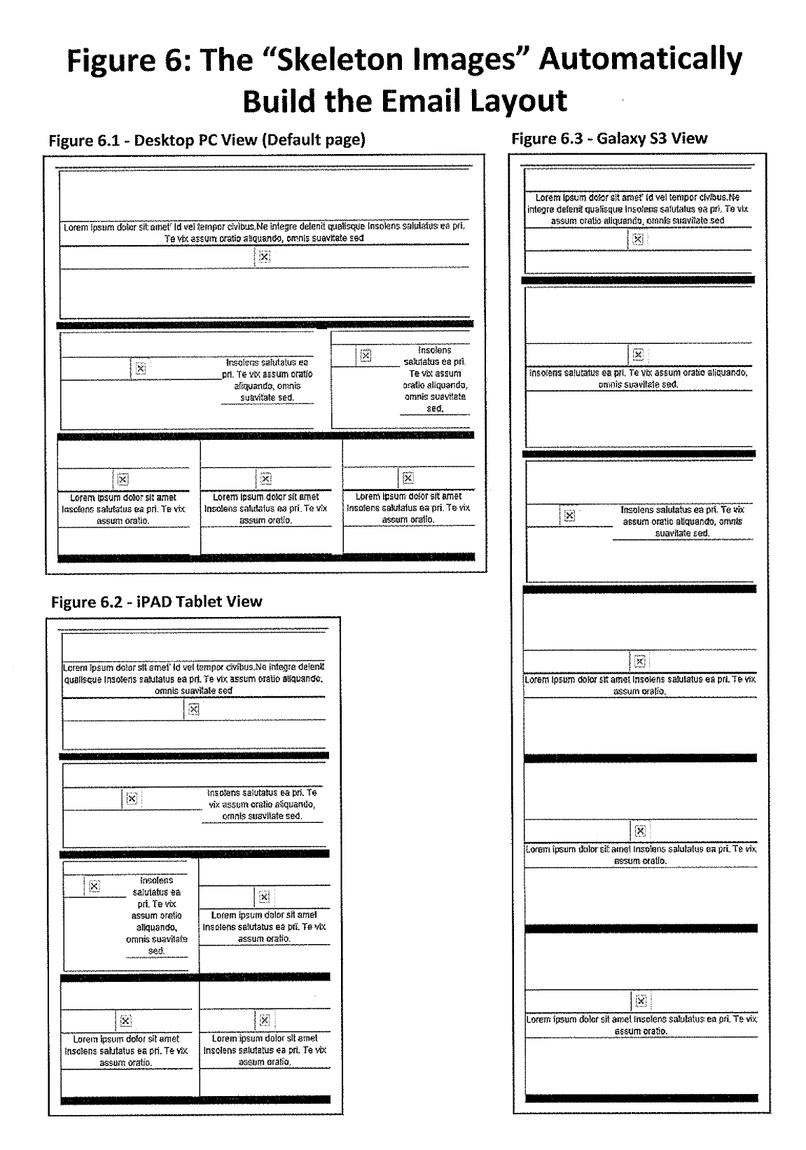

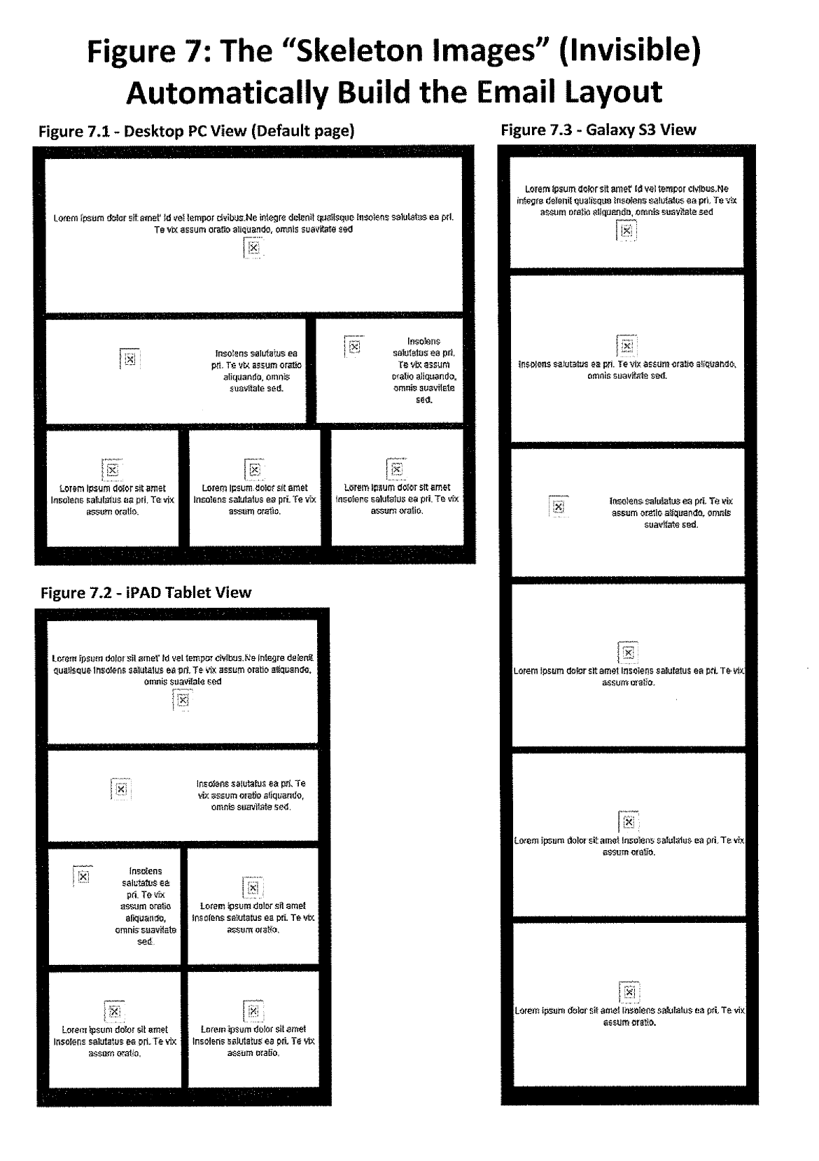

To further illustrate and explain the process, FIGS. 2-7 depict three distinct exemplary email platform views as they appear at various stages of the process. FIG. 2 depicts views/previews of three [simulated] versions of the same email page, as optimized for three different exemplary platforms. The three exemplary platforms are followed throughout the description below. Three versions of the same email are created as real or at least simulated email pages. Each version of the base email is laid out in such a way so that the email can be optimally viewed on one of the three platforms. FIG. 3 depicts the displays of FIG. 2 including various dimensions (in pixels) of objects within the email versions. FIG. 4 depicts exemplary Layout Image Files visibly displayed for the email versions of FIG. 2. The depicted Layout Image Files are created at the authoring/editing stage. FIG. 5 depicts the default layout-less display of the email versions of FIG. 2, at the stage prior to the Layout Image Files and Content Image Files being downloaded and displayed in the emails. FIG. 6 depicts the Layout Image Files of FIG. 4 being displayed on the exemplary platforms, at the stage prior to the Content Image Files being displayed. FIG. 7 depicts the displays of FIG. 6 with the Layout Image Files not visible.

Referring now to FIG. 2, FIG. 2.1 depicts an email displayed on desktop PC, FIG. 2.2 depicts the same email displayed on an iPad™ tablet computer, and FIG. 2.3 depicts the same email a Galaxy S3™ smartphone. Each email version is optimized for display on the respective device/platform. The layout of each email version and resizing the content items and images is handled by the Editor.

The editing process may be manual or automatic. If the process is manual, an operator manually edits the content of the base/sample email page (or what was provided by the marketer in Step 1) by arranging the same content (content items which contain text and/or images) to fit within the predefined display parameters of the respective platform. Herein, the email must include at least one image for the minimal multi-view-email system to be used. If there are no images or graphical elements then there is no particular need for this system. Some content items are reshaped while others are left alone. Some images may be resized while others may remain untouched. If the editing process is automatic then the Editor performs all of the aforementioned changes according to predefined editor decisions, system rules and structure. Each version of the email can have a real or simulated preview page (referred to herein as ‘email preview page’, ‘page preview’ or ‘preview page’ or any combination thereof)

Referring back to FIG. 1, in Step 104 the system Design and Rendering Engine creates Transparent/invisible ‘Skeleton’ Image files or ‘Layout-Images’ (both horizontal and vertical) for each of the various email recipient platforms selected and edits/transforms the marketing email pictures into different sizes to fit each of the various email display parameters of the various platforms. Layout Image Files are discussed in further detail elsewhere herein.

Referring now to FIG. 3, the Figure shows dimensions of objects in the default and transformed views as per the aforementioned Step 104. The same three exemplary views from FIG. 2 are displayed in FIG. 3. It is evident from the detailed dimensions that some of the pictures have been resized (pictures 1-3 in tablet view of FIG. 3.2 and pictures 1-6 in the smartphone view of FIG. 3.3), as have some of the content items (1-3 in tablet view of FIG. 3.2 and 1-6 in the smartphone view of FIG. 3.3) and text boxes (1-3 in tablet view of FIG. 3.2 and 1-6 in the smartphone view of FIG. 3.3). A more complete discussion on Skeleton Images/Layout Image Files and Content Items can be found below. At this point it is sufficient to say that the various graphics/images and layout-images are stored in a repository linked to the email server responsible for sending the multi-view email (see below).

In some embodiments, certain selected content can be displayed on one platform while being hidden on another. For example, a QR code image which is displayed on a desktop may not be relevant to a smartphone. In such a case, the size of the QR code content item in the smartphone version is made to be one [transparent/invisible] pixel, so that for all intents and purposes the image is hidden.

In Step 105 the system generates a single innovative Multi-View Email per job (i.e. The multi-view email is the email that is sent to all the email recipients, regardless of the type of email platform. The multi-view email is a Skeleton-Less or Layout-Less Email HTML. That means that the email has no predefined layout and will be displayed in substantially the same way on all the recipient email platforms (see FIG. 5)—at least initially.

In Step 106 the system server sends the same multi-view HTML-email to all the email recipients, regardless of which platform the email will be displayed on.

In Step 107 the recipient opens the email. Once the email has been opened, only the text is clearly visible and the layout is substantially similar for all platforms (i.e. a default layout). FIG. 5, depicts this state on each of the exemplary email platforms. The lowest common width (in the exemplary Figures this width is 320 pixels which is the maximum display width of the smallest device, the Galaxy S3™) is usually selected as the widest possible display on all the platforms.

In Step 108 the Email Client prompts the user to allow the email client to download the graphic components of the email (as discussed above). This step always occurs, whether the approval is manual or automatic. When this step happens automatically, the views depicted in FIG. 5 will generally not necessarily be seen by the recipient. Once downloading of the graphical components is approved, the recipient email client sends a request to the system email server requesting the missing image files. This request includes data/information regarding the nature of the email platform from which the request was sent.

In Step 109 the system receives the request for the images and identifies the recipient email platform from the identifying information in the aforementioned request. The system then sends the appropriate “Skeleton Image file(s)”/layout-image file(s) as well as the adjusted content graphic/image files. The Layout-Image file(s) immediately build a kind of email layout inside the already downloaded email (see FIG. 6). As can be seen in FIG. 6, the layout-images give the email a layout which is appropriate for the device on which the email is being displayed. Essentially, the Layout Image Files “expand/spread” the email to make optimal use of the space available on the screen of the host device.

In Step 110 the set of image files that have been downloaded together with the layout image files are displayed in the email. The set includes the images that were specifically adjusted to fit into the layout (created by the layout-images) of the particular email platform. The result (Step 111) is that the multi-view email is now displayed in a layout that makes optimal use of the available space on the recipient email platform. Of course, there is also a default email version with default layout-images and graphics that are downloaded when the recipient email platform is not supported, or for some reason not recognized/identified.

### Skeleton/Layout Image Files Content Image Files and Text

Image file formats are standardized means of organizing and storing digital images. Image files are composed of digital data in one of these formats that can be rasterized for use on a computer display or printer. An image file format may store data in uncompressed, compressed, or vector formats. Once rasterized, an image becomes a grid of pixels, each of which has a number of bits to designate its color equal to the color depth of the device displaying it.

Herein, two types of image files are discussed: Content Image Files—refer to files containing pictures, drawings, charts, photos, diagrams and the like; Layout Image Files—are the innovative crux of the immediate invention. When the Layout Image Files are incorporated into the email files (HTML, EMAIL, etc.) they set the geometric parameters/sizes of the graphical and visual elements that are included in the email. Layout Image Files are usually see-through/invisible (i.e. have the same color as the background of the email) and are generally not intended to be seen by the viewer.

Referring now to FIG. 4, the basic skeleton/Layout Image File is an image which has a height of one pixel (although, sometimes it is more convenient to have more than one pixel height) and a width of whatever the maximum width available is. Additionally, the width of the skeleton image is one pixel with the height being maximum height available. (In FIG. 6, the skeleton/Layout Image Files can be seen in practice after being downloaded from the server. The Layout Image Files ‘build’ the email layout and can be clearly seen, just before the content image files are inserted.) In the immediate Figure, the topmost line of FIG. 4.1 is a horizontal skeleton/layout image 42 which defines the layout for the entire email, having a height of one or two pixels and a width of 600 pixels (as we see from FIG. 3.1, the maximum width for desktop PC view is 600 pixels). This is the highest (hierarchically speaking) level of content item table. Within this table are included all the other tables, including content item tables. In the same example and Figure, the next content item table includes text and a [content] image. Further skeleton/Layout Image Files (usually of single pixel thickness, but possibly with a thickness greater than one pixel) build the internal layout to accommodate the text and image content-items. Vertical layout image 44 has a width of 1 pixel and a height dictated by the height of the table in which it appears. Numerous horizontal and vertical Layout Image Files ‘create’ the layout of the page. Layout Image Files are generally invisible in practice, but visible when being created. A thick horizontal layout image 46 is used as a visual separator between the first image and middle two images. The same Layout Image Files visible in FIG. 4 are even more clearly visible in FIG. 6.

Preferably the Layout Image Files are in the Graphics Interchange Format (GIF) or in Portable Network Graphics (PNG). Further preferably, the pixels are transparent (i.e. the same color as the background). In this manner, the size of the transparent GIF/PNG file is very small seeing as only the color and parameters of the image need to be defined. In fact, seeing as all the pixels are the same color, there is practically no difference whether the width of the image is 5 pixels or 500 pixels long. 5 and 500 are simply parameters within the definitions of the GIF/PNG file.

FIG. 3 includes the three different platforms used exemplarily throughout the disclosure. In FIG. 3, the Desktop View (FIG. 3.1) is the default page of how the author of the email wishes the email to be displayed in the desktop PC screen. The system editor transforms the default page into further pages, each one optimized for a specific platform. This point is discussed at length elsewhere in the disclosure. Content items include text and/or images. When transforming the page from the default page to the specialized page, the content items often need to be resized. In FIG. 3, each content item includes a reference number. The positive black numbers refer to content items that have been resized to better fit the specified platform. (In the iPad Tablet view of FIG. 3.2 half the content items have been resized and in the Galaxy S3 view of FIG. 3.3 all the content items have been resized.) When a content item is resized, the text within the content item adapts to the new dimensions of the item without specific attention (the email clients handle text very well). The same cannot be said for Content Image Files.

Content images must be manually or automatically resized (if needs be) by the email author according to the platform on which the images need to be displayed. The [default] images in FIG. 3.1 include dimension information (W×H) in borderless rectangles. In FIGS. 3.2 and 3.3, many of the content images have been adjusted or resized for optimal display. The resized images include dimension information in solid rounded borders (in pixels). (Once again, in the iPad Tablet view of FIG. 3.2 half the content images have been resized and in the Galaxy S3 view of FIG. 3.3 all the content images have been resized.)

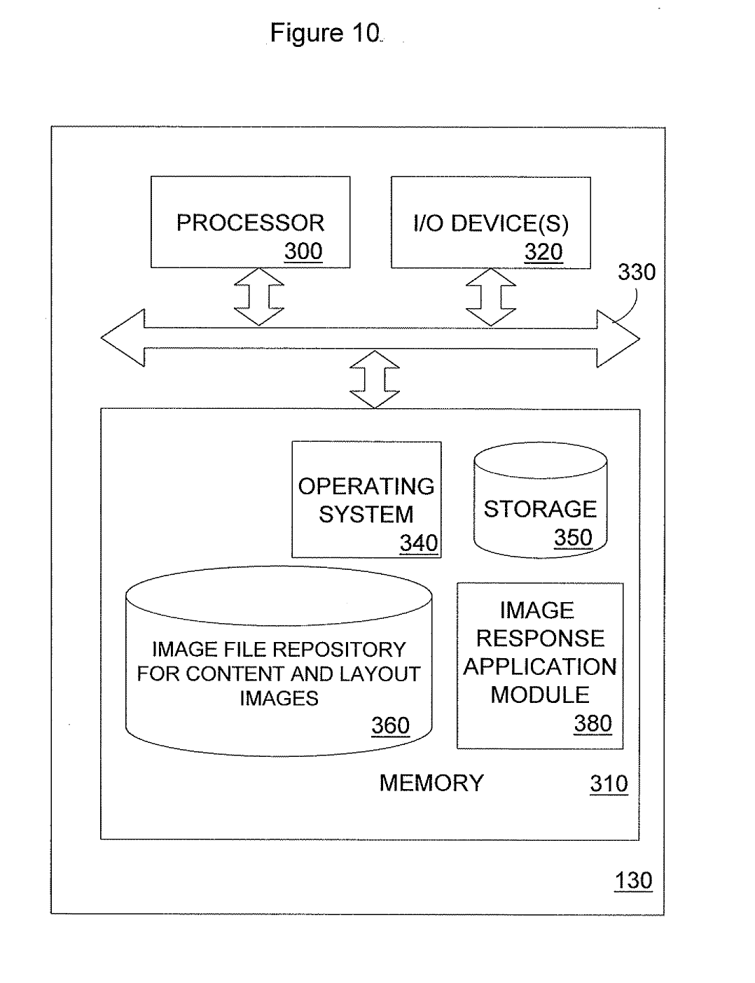

The system, so far as it has been described, includes an Editor and an Email Server. One further component is an Image File Repository residing on the system server (see FIG. 10 for further details). The repository is stored on a non-transitory memory/storage component in which the content image files and layout image files are stored once they have been created and/or edited by the Editor.

Innovatively, the repository for each multi-view email has a number of sub-repositories (i.e. sub-folders on a directory): one sub-repository for each email version. Each sub-repository includes layout image files and content image files with the exact same file names. Therefore, when the HTML script includes a reference to an image file with the filename, the system needs only to direct the request to the correct sub-repository to find the appropriate file, seeing as all the sub-repositories have files with the filename referenced in the email script. Alternatively the same can be achieved by a designated file naming convention (see FIG. 8a as an example of such a file naming convention)

### Image Response Application

The concept is better understood with reference to FIG. 8. FIG. 8 depicts a work flow of a process in the system that redirects an image file request—by the multi-view email—to the folder that contains the appropriate image files for the specific recipient email platform/device.

A multi-view email is opened on a recipient email platform/device. Device 81A is an iPad™ and device 81B is a desktop PC. In Step 82A/B, the devices send an image request (i.e. a request for an image file or set of image files that need to be embedded in the email page—this request is sent either by a manual mouse click or automatically as discussed above) over a data network such as the Internet (Web). The request is received at a web server Image Response Application 83 of the immediate innovative system.

At Step 84 the nature of the recipient email platform is decided/identified based on identifying information sent together with the image request.

At Step 85A/B the request is directed to the appropriate folder (sub-repository) 86A/B according to the identification of the recipient platform/device. Image files (i.e. both the layout image files and the content image files) 87A/B stored within the specific folders are adapted for display on the particular platform with which the folder is identified.

In Step 88A/B the appropriate image files are downloaded/sent to the recipient email platform and displayed in the multi-view email as described elsewhere.

FIG. 8A depicts a work flow for a second embodiment of the re-direct process described above. The same reference numbers have been used to refer to substantially similar elements and/or steps of the process depicted in FIG. 8A as depicted in FIG. 8.

FIG. 8A depicts a work flow of a second embodiment of the process in the system that redirects an image file request—by the email client on which the multi-view email is being displayed—to the repository that contains the image files for the email.

A multi-view email is opened on a recipient email platform/device by an email client. Device 81A is an iPad™ and device 81B is a desktop PC. In Step 82A/B, the devices send an image request (i.e. a request for an image file or set of image files that need to be embedded in the email page—this request is sent either by a manual mouse click or automatically as discussed above) over a data network such as the Internet (Web). The request is received at a web server Image Response Application (IRA) 83 of the immediate innovative system.

At Step 84 the nature of the recipient email platform is decided/identified based on identifying information sent together with the image request.

Based on the type of platform, the IRA accesses a list or logical function 85A/B that knows which Uniquely Named image files need to be retrieved from the repository of image files. In the immediate embodiment, all the Uniquely Named image files are (or can be) stored in one repository as each file has a unique name. For example a picture of a flower sized for iPad 81A is named ipad_flower.gif while the same picture resized for desktop 81B is named pc_flower.gif. All the images can be stored in the same repository because they all have unique file names. Function 85A/B knows which files need to be retrieved from repository for each platform.

In Step 86A/B the IRA retrieves the image file or files from the repository for the desired platform (which has been identified in Step 84).

In Step 87A/B the retrieved image files are renamed or restored to the ‘default name’ of the image file that was requested in the image request step 82A/B. Function 88A/B performs the renaming process. In keeping with our previous example, if iPad 81A request the image file flower.gif then the IRA retrieves the image file ipad_flower.gif (Step 86A) and renames the file to the default name of flower.gif (in Step 87A) which was initially requested.

In Step 89A/B the appropriate image files are downloaded/sent to the recipient/requesting email platform and displayed in the multi-view email as described elsewhere.

In general the IRA performs the aforementioned process primarily for image files which of the Layout Image File type of image files, although the process has been described here referring to both the Content Image Files and the Layout Image Files. Furthermore, even though the first embodiment and second embodiment of the IRA have been described as mutually exclusive embodiments, in practice any combination of the embodiments is also included in the scope of the invention. For example the second embodiment of the IRA may be used for Layout Image Files while the first embodiment configuration is used for the Content Image Files and vice versa.

The IRA can be implemented in a number of different configurations. Three potential, non-limiting, configurations are discussed:

1. The IRA is installed and integrated into a fully operational system capable of performing all of the steps of the invention from the authoring stage to the editing stage of the images to the creation and distribution of the multi-view email to supporting the retrieval and sending of the desired image file(s) to the recipient email clients/platforms (by the IRA).

2. The IRA is installed as an add-on module to an existing email system (common implementation is via an API) The Application is installed as an independent [software and/or firmware and/or hardware] module in the Service Provider servers. The edited image files (layout image files and/or content image files) are created/edited by a separate system and made available to the IRA application. The IRA functions to identify the type of platform that sends the image requests and provide or direct the system to the correct image files.

3. The IRA is installed on a proxy server that serves Email servers that use this invention. The proxy server is adapted for providing web-based services to a number of different email/web systems. The systems upload or create the image files on the proxy server. The email systems integrate the direct links to the image files on the proxy server in the emails. When an image request arrives from a recipient platform, the IRA—integrated with the proxy server—receives the request and then selects the appropriate image files and forwards them to the email recipient platforms.

### Structure of Email

The graphically enhanced HTML email that the system must reproduce in various layouts is built from tables of content items/objects containing further tables of content items and so on. The content of the content items/objects are either text or image. Each table represents a hierarchically level of the email (a fractal binary tree). The tables of content items are essentially ‘nested’ (like nesting cups), one within the other within the other and so forth. That means that the email itself is a table that displays the highest level content items. Within the table are additional tables that display content items of a lower level, including content items such as: email header, email body, footer, policy etc. As a default, the content items are organized one after the other (display:inline-table) in order to create some flexibility as to how the tables will be displayed, within the confines of the width of the parent or hosting table. The email client organizes the content items in the same way that text is wrapped, so that if there is no more space in the current row for the next item, then the item is displayed in the next row. The width of a parent table is the border-edge width of the table inside it. At the point where wishing to stop the sequence of content items from being displayed one after the other (in ‘text-wrap’ fashion), the last item is defined as a block (display:block as opposed to display:inline-table), such that no further item appears in the same row. Each content item table is defined with a minimum width (min-width). On the other hand, each content item table is also defined with a width of one pixel (width:1px). Defining the table as having a width of one pixel prevents the table from being stretched over the entire area available from the parent table/node (parentNode), as the table is always trying to shrink back to the width of one pixel. The table cannot actually go back to the width of one pixel because of the predefined minimum width of the content object (for example, the whole email, section, content item etc, where the min-width is actually bigger than one pixel). So the table actually has a flexible width, which is constantly trying to contract to one pixel width. When an image is introduced into the table (real image or skeleton image), the table size is expanded to conform to the parameters of both the layout and content images (or to conform to the minimum size instead).

Tables that are not themselves content item tables but are within such a table, inherit the minimum size of the parent content item table of the closest hierarchical level as discussed above. This size will itself be diminished due to geometrical entities and design components such as Padding, Border, Margin, etc.

Each content item table includes at least one cell. The cell includes a skeleton/layout image width which is defined as a block (dispay:block) which displays the width of the item. Immediately thereafter, within the same cell, appears the table with the content item. In the same content item table there can be additional cells which contain additional skeleton/Layout Image Files for setting the dimensions of the item or images that define other geometrical entities and design components such as Padding, Border, Margin, etc.

The content table that contains the content of the content item is defined as table-layout:fixed, in order to ensure a solid, non-flexible, size of the table relative to the parent (parent Node whose size is defined by the skeleton/Layout Image Files that it contains or the node's minimal width), and is not influenced by the content contained there-within.

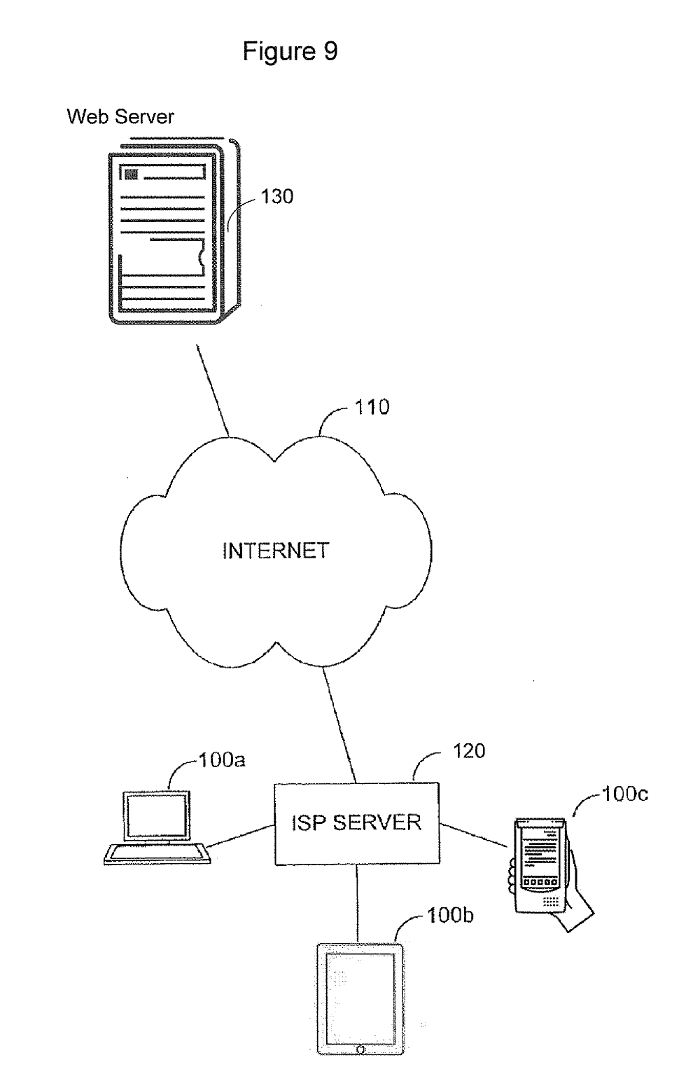

FIG. 9 shows a block diagram illustrating an architecture used for email transport and delivery used in several embodiments of the present invention. Each of a plurality of remote computing devices 100a-100c accesses the Internet 110 (or other network) through a local Internet service provider (ISP) server 120, (or other gateway systems). It should be recognized by one skilled in the art that the ISP server 120, can offer access to the Internet 110 through a plethora of connection types, including a digital subscriber line (DSL) service, an integrated services digital network (ISDN) service, an analog dial-up service, Ethernet, T-1, or any other service for transmitting data through a network. A Web Server 130 is connected to the Internet 110. This Internet connectivity enables the TSP server 120 and other servers connected to the Internet to transfer information between computing devices 100a-100c and Web Server 130 of the immediate invention using various protocols that are recognized by the servers.

With specific regard to email, the TSP server 120 generally includes both a post office protocol 3 (POP3) server and a simple mail transfer protocol (SMTP) server capable of supporting multipurpose Internet mail extension (MIME) encoded files. Typically, the email clients on computing devices 100a-100c include a POP3 component and an SMTP component with MIME encapsulation for non-ASCII attachments. The SMTP component on web server 130 can transfer an email message in SMTP format to the SMTP server residing on an ISP server 120 where it is stored on the POP3 server. Alternatively, one skilled in the art should recognize that the POP3 server can be replaced by an Internet message access protocol 4 (IMAP4) server which can perform all of the POP3 functions, and that has features additional functions for flexibility and efficiency. As mentioned before, the computing devices 100a-100c each have an email client that includes a POP3 component. The POP3 component on the computing device 100a-100c can contact the POP3 server on the local ISP server 120 and retrieve messages for the user logged in to the client on the respective computing device 100a-100c.

FIG. 10 shows a block diagram of an embodiment of web server 130 shown in FIG. 9. As known to those skilled in the art, a computer system typically includes a processor 300, memory 310 and input/output (I/O) device(s) 320, all communicating over a bus 330. The memory typically includes the operating system 340 and non-volatile storage 350. The operating system is typically stored in non-volatile memory while the Web Server 130 is turned off, and loaded into volatile memory upon start-up, where it can be executed by the processor 300. In the present embodiment, the memory 310 further includes an Image File Repository 360 (or a plurality thereof) located either locally, remotely or a combination thereof. Image File Repository 360 includes a plurality of sub repositories (e.g. subfolders) for storing various versions of the same content image files and layout image files for use in the immediate system as described above. Image File Repository 360 may be integrated into memory 310 as depicted in FIG. 10, or otherwise remotely located or even partially remotely located. Memory 310 further includes an Image Response Application module 380 including the logic of image response application 83 discussed in detail with regards to FIG. 8 above.

The computing logic of the present invention, such as image response application 83, can be implemented in hardware, software, firmware, or a combination thereof. In the preferred embodiment(s), image response application 83 is implemented in software or firmware that is stored in a memory and that is executed by a suitable instruction execution system. If implemented in hardware, as in an alternative embodiment, image response application 83 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for providing an email that is configured to be displayed according to display parameters of an email platform upon which the email is displayed, the method comprising:
(a) obtaining a plurality of sets of image files, each said set of image files adapted to be displayed according to display parameters of a respective email platform;
(b) sending a multi-view email to a recipient email platform;
(c) receiving an image request from said recipient email platform; and
(d) sending a said set of image files adapted for display on a said email platform similar to said recipient email platform.

2. The method of claim 1, wherein each said set of image files includes:
(i) at least one content image file; and
(ii) at least one layout image file.

3. The method of claim 1, wherein said image request includes information identifying said recipient email platform.

4. The method of claim 3, further comprising a step of:
(e) retrieving said set of image files adapted for display on said email platform similar to said recipient email platform based on said identifying information; wherein step (e) is performed prior to step (d).

5. The method of claim 4, wherein said step of retrieving is performed by an Image Response Application (IRA) adapted to redirect said image request, based on said identifying information, to a sub-repository containing said set of image files adapted for display on said email platform similar to said recipient email platform.

6. The method of claim 4, wherein said step of retrieving is performed by an Image Response Application (IRA) adapted to retrieve said set of image files adapted for display on said email platform similar to said recipient email platform from an Image File Repository and rename said set of images to conform with requested image files included in said image request.

7. The method of claim 1, wherein said multi-view email includes only non-executable instructions.

8. The method of claim 1, wherein said multi-view email is configured to display substantially similar content on each said respective email platform.

9. The method of claim 8, wherein at least some of said substantially similar content is invisible when displayed on at least one of said respective email platforms.

10. The method of claim 8, wherein said substantially similar content includes indicia of source from which said substantially similar content originated.

11. A system for preparing a multi-view email adapted to be displayed according to display parameters of an email platform upon which the email is displayed, comprising:
(a) a Layout Image File creator for creating a respective set of Layout Image Files for display on each of a plurality of email platforms;
(b) an Image Editor adapted to edit a respective set of Content Image Files to conform to a respective said set of Layout Image Files; and
(c) a multi-view email creator configured to creating a single multi-view email configured to display a said set of Layout Image Files and a said set of Content Image Files adapted for display according to display parameters of a said email platform similar to a recipient email platform upon which said multi-view email is being displayed.

12. An email system for distributing a multi-view email adapted to be displayed according to display parameters of an email platform upon which the email is displayed, comprising:
(a) an Image File Repository (IFR) configured to store image files; and
(c) an Image Response Application (IRA) operationally coupled to said IFR and configured to respond to image requests from recipient email platforms;
wherein the multi-view email is configured to display substantially similar content respectively on each of a plurality of said recipient email platforms.

13. The email system of claim 12, wherein said image files include:
(i) at least one Layout Image File, and
(ii) at least one Content Image File.

14. The email system of claim 12, wherein said image requests include identifying information identifying said recipient email platform displaying the multi-view email.

15. The email system of claim 14, wherein said IRA, is response to a said image request, is adapted to retrieve image files from said IFR based on said identifying information in said image request.

16. The email system of claim 15, wherein said retrieved image files are renamed to conform to requested image files included in said image request.

17. The email system of claim 15, wherein said IFR includes a plurality of sub-repositories, wherein each respective said sub-repository being identified as corresponding to a respective said recipient email platform and wherein each said sub-repository is adapted to store image files adapted for display on said corresponding recipient email platform.

18. The email system of claim 17, wherein said IRA is configured to redirect said image request, based on said identifying information, to a said sub-repository corresponding to said recipient email platform identified by said identifying information.

19. A computer-readable medium having computer-readable code for displaying a multi-view email on a programmable receiving email client according to display parameters of an email platform running the email client, the computer-readable medium comprising:
(a) computer-readable code adapted to instruct the email client to display content of a hypertext markup language (HTML) formatted email message within a default width;
(b) computer-readable code adapted to instruct the email client to send an image request for image files from an email server, wherein said image request includes information identifying the email platform; and
(c) computer-readable code adapted to instruct said email client to download and display said image files;
wherein said image files include at least one Layout Image File adapted to provide the email client with parameters for displaying said content, wherein said parameters conform to the display parameters of the email platform running the email client.

20. The computer-readable medium of claim 19, wherein said image files further includes at least one Content Image File adapted to be displayed within said at least one Layout Image File.
